(19) United States
(12) Patent Application Publication
(10) Pub. No.: US 2005/0277439 A1
(43) Pub. Date: Dec. 15, 2005

(54) Rotatable phone

(76) Inventors: Nora Brelo, Oulu (FI); Tapani Jokinen, Piispanristic (FI)

Correspondence Address: PERMAN & GREEN, 425 POST ROAD, FAIRFIELD, CT, 06824, US

(21) Appl. No.: 10/867,042

(22) Filed: Jun. 14, 2004

(51) Int. Cl. H04M 1/00

(52) U.S. Cl. 455/556.2; 455/575.3; 455/575.1

(57) ABSTRACT

A hand-portable electronic device comprising a first body part comprising a display; a second body part having a first face and a second face and comprising a first input device located on the first face and a second input device located on the second face; and a swivel connecting the first and second parts and enabling relative rotational movement of the first and second body parts between a first operative configuration in which the first input device and display are facing in a first direction and a second operative configuration in which the second input device and display are facing in the first direction.

### FIELD OF THE INVENTION

An electronic device having a first body part and a second body part that rotates relative to the first body part.

### BACKGROUND TO THE INVENTION

As technology progresses, it is desirable to add more functions to each electronic device to make it more useful to its user. For example, in the mobile cellular telephone industry it is now common practice to integrate a digital camera into the telephone. However, users also typically want small, elegant devices that can be carried in the hand, in a pocket or in a handbag.

There is a tension between a desire to add new functions to a device on one side and a desire to keep the device small and easy to use on the other side.

It would be desirable to find a way of increasing the functionality of an electronic device, in particular a hand-portable electronic device, without significantly increasing its size/the number of accessories required/its complexity of use.

### BRIEF DESCRIPTION OF THE INVENTION

According to one embodiment of the invention there is provided a hand-portable electronic device comprising: a first body part comprising a display; a second body part having a first face and a second face and comprising a first input device located on the first face and a second input device located on the second face; and a swivel connecting the first and second parts and enabling relative rotational movement of the first and second body parts between a first operative configuration in which the first input device and display are facing in a first direction and a second operative configuration in which the second input device and display are facing in the first direction. In this space saving embodiment, the device has two separated input devices that can be rotated relative to a display and can thus share a single display.

According to another embodiment of the invention there is provided a hand-portable electronic device comprising: a first body part comprising a front face that includes a display and a side face adjacent the front face; a second body part comprising a first face including a first input device, a second face including a second input device adjacent the first face, a third face opposite the first face and adjacent the second face and a fourth face adjacent the first face and opposite the second face, wherein the separation between the opposing first and third faces is less than the separation between the opposing second and fourth faces; and a swivel connecting the first and second parts and enabling relative rotational movement of the first and second body parts between a first operative configuration in which the first input device and display are facing in a first direction and a second operative configuration in which the second input device and display are facing in the first direction, wherein in the second configuration the second body part acts as a prop for abutting a surface and supporting the first body portion with its side face towards the surface such that the first direction is pointing way from and is inclined to the surface. In this embodiment, the device is self-supporting. There is no need to carry a separate supporting stand for the device.

According to another embodiment of the invention there is provided an electronic device comprising: a first body part comprising a display; a second body part having a first face and a second face and comprising a first input device located on the first face and a second input device located on the second face; a swivel connecting the first and second parts and enabling relative rotational movement of the first and second body parts between a first operative configuration in which the first input device and display are facing in a first direction and a second operative configuration in which the second input device and display are facing in the first direction; a mechanism for detecting the relative position of the two body parts; and processing circuitry that responds to the establishment of the second operative configuration by automatically loading computer program instructions for providing an application that provides output via the display and accepts input via the second input device. The automatic loading of the application associated with the current input device makes the device simple and intuitive to use.

### BRIEF DESCRIPTION OF THE DRAWINGS

For a better understanding of the present invention reference will now be made by way of example only to the accompanying drawings in which:

FIGS. 1A, 1B, 1C and 1D illustrate a hand-portable electronic device 100, such as a mobile cellular telephone.

FIGS. 2; 3A and 3B; 4; and 5A, 5B and 5C illustrate four different operative configurations of the electronic device; and

FIG. 6 schematically illustrates the functional component parts of the electronic device.

### DETAILED DESCRIPTION OF EMBODIMENTS OF THE INVENTION

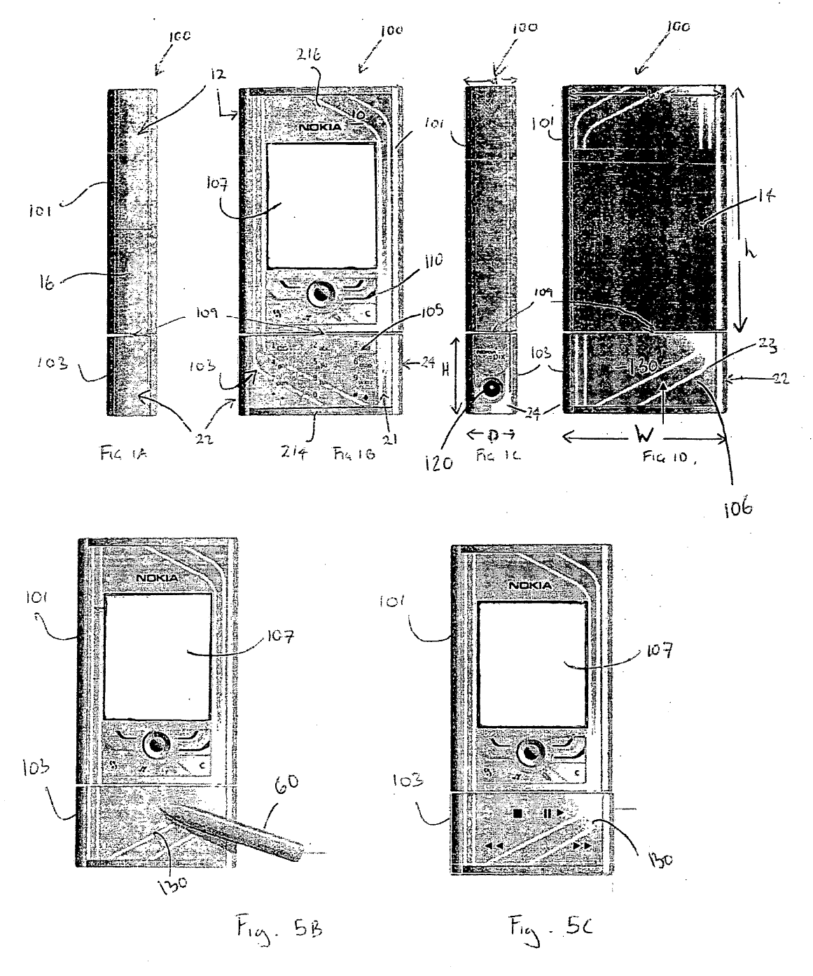

FIGS. 1A, 1B, 1C and 1D illustrate a hand-portable electronic device 100, such as a mobile cellular telephone. FIG. 1B illustrates a front perspective view. FIG. 1A illustrates a perspective view taken from the left side of FIG. 1B. FIG. 1C illustrates a perspective view taken from the right side of FIG. 1B. FIG. 1D illustrates a rear perspective view.

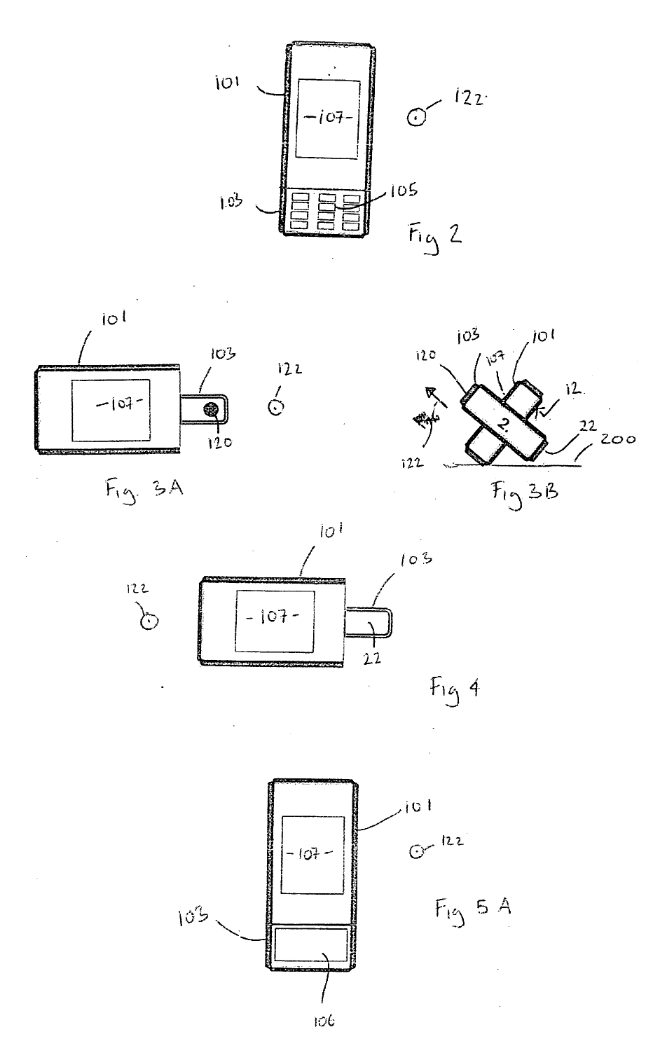

The electronic device 100 comprises: a first body part 101; a second body part 103 and a swivel hinge 109 connecting the first body part 101 and the second body part 103. The swivel hinge 109 allows relative rotational movement of the first body part 101 and the second body part 103, by a user, as illustrated in FIG. 2, FIGS. 3A and 3B, FIG. 4 and FIGS. 5A, 5B and 5C and as described later.

The first body part 101 comprises a front face 10 and a side face 12, which is adjacent the front face 10 and substantially orthogonal to the front face 10 such that the two faces meet at an edge. The first body part 101 has a width w, a depth d and a height h.

The front face 10, as illustrated in FIG. 1B, includes the display 107, function keys 110 below the display 107 and a loudspeaker 216 above the display 107.

The side face 12, as illustrated in FIG. 1A, includes a door 16 which provides access to one or more Input or Output interfaces of the device, such as a reader for a SIM card, and/or a memory card, and/or a mini-USB interface.

The rear of the electronic device, as illustrated in FIG. 1D has a door 14 behind which the battery cell for the device is located.

The second body part 103 comprises a front face 21, a first side face 22, a back face 23 and a second side face 24. The front face 21 is adjacent and orthogonal to the side face 22 which it meets at a first edge, adjacent and orthogonal to the side face 24 which it meets at a second edge, and opposite the back face 23. The back face 23 is adjacent and orthogonal to the side face 22 which it meets at a third edge, adjacent and orthogonal to the side face 24 which it meets at a fourth edge, and opposite the front face 21. The first side face 22 is adjacent and orthogonal to the front face 21 which it meets at the first edge and adjacent and orthogonal to the back face 23 which it meets at the third edge, and opposite the second side face 24. The second side face 24 is adjacent and orthogonal to the front face 21 which it meets at the second edge, adjacent and orthogonal to the back face 23 which it meets at the fourth edge, and opposite the first side face 22. The front face 21, first side face 22, back face 23 and second side face 24 form a cuboid with rounded first, second, third and fourth edges.

The second body part 103 has a width W, a depth D and a height H. The depth D corresponds to the separation between the opposing front face 21 and back face 23 and is significantly less than the width W corresponding to the separation between the opposing first side face 22 and second side face 24. Typically, the width W is several times grater that the depth D. The height H can be smaller, larger or equal to the height h. Both of the height H and h are larger than the depth d.

The front face 21 includes a first touch sensitive actuation means such as a keypad input device 105. In this example, as the electronic device is a cellular radiotelephone, the front face 21 includes a microphone 214 and the keypad input device 105 is a ITU-T keypad. The ITU-T keypad is a 4 row by three column array of keys.

The second side face 24 includes a digital camera input device 120 The back face 23 includes a second touch sensitive actuation means such as a touch pad input device 106 that has a touch sensitive area 130.

The first side face 22, in this example, does not include an input device.

The swivel hinge 109 allows relative rotational movement of the first body part 101 and the second body part 103, by a user, in 90 degree increments between different operative configurations as illustrated in FIG. 2, FIGS. 3A and 3B, FIG. 4 and FIGS. 5A, 5B and 5C.

FIG. 2 illustrates an operative configuration in which the keypad input device 105 and display 107 are facing in a first direction 122 that comes out of the page. This operative configuration is also illustrated in FIGS. 1A-1D.

FIGS. 3A and 3B illustrate an operative configuration in which the digital camera input device 120 and the display 107 are facing in the first direction 122. FIG. 3A is a front view of the display 107 and FIG. 3B is a side view. In FIG. 3A the first direction 122 is out of the page and in FIG. 3B it is upwardly angled, from right to left. This operative configuration results from rotating the second body part 103 through 90 degrees in an anticlockwise direction when it is in the configuration illustrated in FIG. 2.

In FIG. 3B the device 10 is resting on a flat planar surface 200, such as a desk-top. The second body part 103 acts as a prop for the first body part 101. The second body part 103 abuts the surface 200 and supports the first body portion 101 with its side face 12 towards the surface 200 such that the first direction 122 is pointing way from and is inclined at an angle Θ to the surface 200. As the second body part is centrally mounted on the swivel hinge 109 and the widths W and w are the same, the angle Θ is 45 degrees.

FIG. 4 illustrates an operative configuration in which the digital camera input device 120 and the display 107 are facing in opposite directions. This operative configuration results from rotating the second body part 103 through 90 degrees clockwise when it is in the configuration illustrated in FIG. 2.

FIGS. 5A, 5B and 5C illustrate an operative configuration in which the touch pad input device 106 and the display 107 are facing in the first direction 122, which is out of the page. This operative configuration results from rotating the second body part 103 through 180 degrees when it is in the configuration illustrated in FIG. 2.

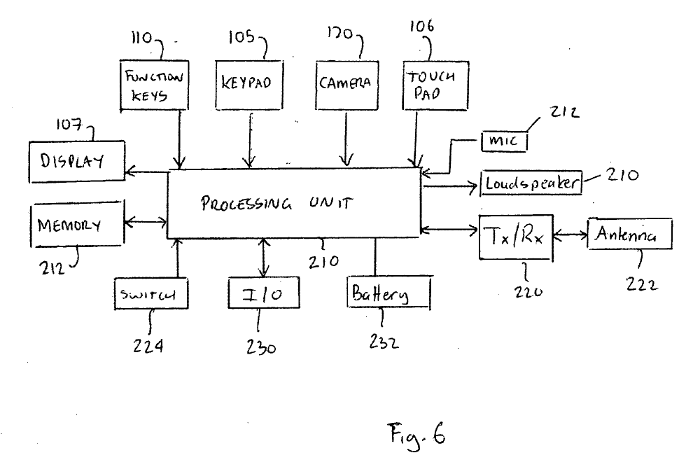

FIG. 6 schematically illustrates an example of the functional components parts of the electronic device 10. The device 10 comprises: a processing unit 210; a memory unit 212, a display 107, function keys 110; a keypad input device 105; a digital camera input device 120; a touch pad input device 106 that has a touch sensitive area 130;_a switch mechanism 224 for detecting the relative position of the two body parts 102,103; input/output interfaces 230 of the device, such as a reader for a SIM card, and/or a memory card, and/or a mini-USB interface; and a battery cell 232. As the example device 10 is a hand-portable mobile cellular telephone, the device 19 also comprises a radio transceiver 220 connected to an (internal) antenna 222, a microphone 214, and a loud speaker 216.

The processing unit 210 is connected separately to read from and write to the memory 212, the input/output interfaces 230 and the radio transceiver unit 220. The processing unit is connected to receive control signals from the function keys 110, the microphone 212, the switch mechanism 224, the keypad input device 105, the camera input device 120, and the touch pad input device 106. The processing unit is connected to provide control signals to the display 107 and the loudspeaker 210. It is powered by the connected battery cell 232.

The processing unit 210 may a dedicated processing unit such as an ASIC, but is preferably a programmable microprocessor the operation of which is controlled by computer program instructions loaded from the memory 212. Typically, the electronic device will be multi-functional. Each function is provided by loading a different set of computer program instructions (an application) from the memory 212. Each application controls the operation of the processing unit 210. These computer program instructions may, for example, cause the processing unit to:
a) provide a particular graphical user interface on the display 107 and/or touchpad 106 (if it incorporates a display),
b) restrict the input devices from which the processing unit will take commands
c) control how the processing unit 210 provides an output.

Therefore as an operative configuration is brought into being, by rotating the second body part 103 with respect to the first body part 101, one input device may be enabled while another input device is disabled.

The switch mechanism 224 detects the establishment of one of the operative configurations described with reference to FIGS. 2 to 5. When a new operative configuration is established, a signal identifying the operative configuration is automatically provided by the switch mechanism 224 to the processing unit 210. The processing unit 210 responds by automatically reading from the memory 212 a set of computer program instructions (an application) corresponding to the identified configuration and loading these instructions. The processing unit 210 therefore automatically loads a new application when an operative configuration is established.

When the operative configuration illustrated in FIG. 2 is established, the keypad input device 105 is rotated to face in the first direction 122 with the display 107. The processing unit 210 automatically loads computer program instructions for an application that provides output via the display 107 and accepts input via the keypad input device 105. Typically, the application will ignore any input from the touchpad input device 106.

When the operative configuration illustrated in FIGS. 3A and 3B is established, the camera input device 120 is rotated to face in the first direction 122 with the display 107. The processing unit 210 automatically loads computer program instructions for an application that provides output via the display 107 and accepts input via the camera input device 120. This application typically provides an image capture mode such as video conferencing. The orientation of the device 10 illustrated in FIG. 3B is particularly useful for video-conferencing as it allows hands free use.

When the operative configuration illustrated in FIG. 4 is established, the camera input device 120 is rotated to face away from the first direction 122 in which the display 107 faces. The processing unit 210 automatically loads computer program instructions for an application that provides output via the display 107 and accepts input via the camera input device 120. This application may provide an image capture mode. Typically, the application is a video camera application and the digital camera 120 is used in a digital video camera mode.

When the operative configuration illustrated in FIG. 5A is established, the touchpad input device 106 is rotated to face in the first direction 122 with the display 107. The processing unit 210 automatically loads computer program instructions for an application that provides output via the display 107 and accepts input via the touchpad input device 106 but not via the keypad input device 105. This application may accept handwritten input as illustrated in FIG. 5B. A stylus 60 is moved over the touch sensitive area 130. The application may for example allow handwritten messages or drawings to be created and/or may provide for handwriting recognition. This is particularly useful if the handwriting recognition application is used for character languages such as Chinese, Korean and Japanese. The automatically loaded application may alternatively provide a play back mode as illustrated in FIG. 5C. In this example, the touchpad input device has a plurality of touch sensitive areas each of which has a different symbol representing a different function such as ‘play’, ‘pause’, ‘stop’, ‘back’, forward. The touchpad may be dedicated to this application, in which case the symbols are permanently marked on the touch sensitive are 130. Alternatively, the touch pad may be used with other applications and may be integrated with a display, in which case the symbols can be presented using the integrated display.

Although embodiments of the present invention have been described in the preceding paragraphs with reference to various examples, it should be appreciated that modifications to the examples given can be made without departing from the scope of the invention as claimed. For example although the automatic loading of applications is described in relation to the establishment of each configuration, it should be realized that in some embodiments of the invention there is no automatic loading of an application when an operative configuration is established and in other embodiments of the invention only one or more of the operative configurations has an associated application that loads automatically when that operative configuration is established.

Although, only automatically loaded applications have been described in relation to the operative configurations, it should be realized that in some embodiments each operative configuration is not necessarily dedicated to one application and the user may change the application used in a particular operative configuration or select a particular application for automatic loading when a particular operative configuration is established.

1. A hand-portable electronic device comprising:
a first body part comprising a display;
a second body part having a first face and a second face and comprising a first input device located on the first face and a second input device located on the second face; and
a swivel connecting the first and second parts and enabling relative rotational movement of the first and second body parts between a first operative configuration in which the first input device and display are facing in a first direction and a second operative configuration in which the second input device and display are facing in the first direction.

2. A hand-portable electronic device as claimed in claim 1, wherein the first input device comprises a first touch sensitive actuation means and the first configuration is a first user input mode and the second input device comprises a digital camera and the second configuration is an image capture mode.

3. A hand-portable electronic device as claimed in claim 2, wherein first touch sensitive actuation means comprises a plurality of keys.

4. A hand-portable electronic device as claimed in claim 2, wherein the first touch sensitive actuation means comprises a touch sensitive area.

5. A hand-portable electronic device as claimed in claim 4, wherein the first user input mode is a handwriting recognition mode.

6. A hand-portable electronic device as claimed in claim 4, wherein the first user input mode is a drawing mode.

7. A hand-portable electronic device as claimed in claim 2, wherein the second input device comprises a digital camera and the second operative configuration is an image capture mode.

8. A hand-portable electronic device as claimed in claim 7, wherein the image capture mode is a video conferencing mode.

9. A hand-portable electronic device as claimed in claim 2, wherein the first and second faces of the second body part are adjacent, and the second body part further comprises a third face opposite the first face and adjacent the second face and a fourth face adjacent the first face and opposite the second face, the third face including a third input device wherein the swivel enables relative rotational movement of the first and second body parts into a third operative configuration in which the third input device and display are facing in the first direction.

10. A hand-portable electronic device as claimed in claim 9, wherein the third input device comprises a second touch sensitive actuation means.

11. A hand-portable electronic device as claimed in claim 1, further comprising a mechanism for detecting the relative position of the two body parts; and processing circuitry that responds to the establishment of the second operative configuration by automatically loading computer program instructions for providing an application that provides output via the display and accepts input via the second input device.

12. A hand-portable electronic device as claimed in claim 11, wherein the application provides output via the display and accepts input via the second input device but not via the first input device.

13. A hand-portable electronic device as claimed in claim 11, wherein the second input device is a digital camera and the application enables image capture via the digital camera.

14. A hand-portable electronic device as claimed in claim 11, wherein the second input device is a digital camera and the application enables video conferencing using the digital camera.

15. A hand-portable electronic device as claimed in claim 11, wherein the processing circuitry responds to the establishment of the first operative configuration by automatically loading first computer program instructions for providing a first application that provides output via the display and accepts input via the first input device.

16. A hand-portable electronic device as claimed in claim 1, wherein the the first body part comprises a front face that includes the display and a side face adjacent the front face and the second body part further comprises a third face opposite the first face and adjacent the second face and a fourth face adjacent the first face and the third face and opposite the second face, wherein the separation between the opposing first and third faces is less than the separation between the opposing second and fourth faces and wherein in the second configuration the second body part acts as a prop for abutting a surface and supporting the first body portion with its side face towards the surface such that the first direction is pointing way from and is inclined to the surface.

17. A hand-portable electronic device as claimed in claim 1, wherein the first body part and second body part are rotatable relative to each other in 90 degree increments.

18. A hand-portable electronic device comprising
a first body part comprising a front face that includes a display and a side face adjacent the front face;
a second body part comprising a first face including a first input device, a second face including a second input device adjacent the first face, a third face opposite the first face and adjacent the second face and a fourth face adjacent the first face and opposite the second face, wherein the separation between the opposing first and third faces is less than the separation between the opposing second and fourth faces; and
a swivel connecting the first and second parts and enabling relative rotational movement of the first and second body parts between a first operative configuration in which the first input device and display are facing in a first direction and a second operative configuration in which the second input device and display are facing in the first direction,
wherein in the second configuration the second body part acts as a prop for abutting a surface and supporting the first body portion with its side face towards the surface such that the first direction is pointing way from and is inclined to the surface.

19. A hand-portable electronic device as claimed in claim 18, wherein the first input device comprises a first touch sensitive actuation means and the first configuration is a first user input mode and the second input device comprises a digital camera and the second configuration is an image capture mode.

20. A hand-portable electronic device as claimed in claim 19, wherein the image capture mode is a video conferencing mode.

21. A hand-portable electronic device as claimed in claim 18, wherein the first body part and the second body part are rotatable relative to each other in 90 degree increments.

22. A hand-portable electronic device as claimed in claim 18, wherein the third face of the first body part includes a third input device, wherein the swivel enables relative rotational movement of the first and second body parts into a third operative configuration in which the third input device and display are facing in the first direction.

23. A hand-portable electronic device as claimed in claim 22, wherein the third input device comprises a second touch sensitive actuation means.

24. A portable electronic device, for video conferencing, comprising
a first body part comprising a front face that includes a display and a side face adjacent the front face;
a second body part comprising a first face, a second face including a digital camera adjacent the first face, a third face opposite the first face and adjacent the second face and a fourth face adjacent the first face and opposite the second face, wherein the separation between the opposing first and third faces is less than the separation between the opposing second and fourth faces; and
a swivel connecting the first and second parts and enabling relative rotational movement of the first and second body parts between a first configuration in which the first face and display are facing in a first direction and a second operative configuration in which the digital camera and display are facing in the first direction,
wherein in the second operative configuration the second body part provides a prop for abutting a surface and supporting the first body portion with its side face towards the surface such that the first direction is pointing way from and is inclined to the surface.

25. An electronic device comprising
a first body part comprising a display;
a second body part having a first face and a second face and comprising a first input device located on the first face and a second input device located on the second face;
a swivel connecting the first and second parts and enabling relative rotational movement of the first and second body parts between a first operative configuration in which the first input device and display are facing in a first direction and a second operative configuration in which the second input device and display are facing in the first direction;
a mechanism for detecting the relative position of the two body parts; and processing circuitry that responds to the establishment of the second operative configuration by automatically loading computer program instructions for providing an application that provides output via the display and accepts input via the second input device.

26. An electronic device as claimed in claim 25, wherein the first input device comprises a first touch sensitive actuation means and the second input device comprises a digital camera.

27. An electronic device as claimed in claim 26, wherein the application enables image capture via the digital camera.

28. An electronic device as claimed in claim 27, wherein the application enables video conferencing using the digital camera.

29. An electronic device as claimed in claim 26, wherein the first touch sensitive actuation means comprises a plurality of keys.

30. An electronic device as claimed in claim 26, wherein the first touch sensitive actuation means comprises a touch sensitive area.

31. An electronic device as claimed in claim 25, wherein the processing circuitry responds to the establishment of the first operative configuration by automatically loading first computer program instructions for providing a first application that provides output via the display and accepts input via the first input device.

32. An electronic device as claimed in claim 31, wherein the first input device comprises a touch sensitive area and the first application enables handwriting recognition using the touch sensitive area.

33. An electronic device as claimed in claim 31, wherein the first input device comprises a touch sensitive area and the first application enables drawing input using the touch sensitive area.

34. An electronic device as claimed in claim 25, wherein the application provides output via the display and accepts input via the second input device but not via the first input device.

35. An electronic device as claimed in claim 31, wherein the first application provides output via the display and accepts input via the first input device but not via the second input device.
